(19) United States
(12) Patent Application Publication
(10) Pub. No.: US 2017/0068398 A1
(43) Pub. Date: Mar. 9, 2017

(54) METHOD AND SYSTEM FOR INFORMATION PRESENTATION

(71) Applicant: CONNECTED LIVING, INC., Quincy, MA (US)

(72) Inventors: Lawrence W. Rosenfeld, Quincy, MA (US); Leslie Dwight, Quincy, MA (US); Sarah Holt, Quincy, MA (US); Anna Hall, Quincy, MA (US); Ade Jimoh, Quincy, MA (US)

(73) Assignee: CONNECT LIVING, INC., Quincy, MA (US)

(21) Appl. No.: 14/710,081

(22) Filed: May 12, 2015

Related U.S. Application Data
(60) Provisional application No. 61/992,182, filed on May 12, 2014.

(51) Int. Cl. G06F 3/0482; G06F 3/0488; G06F 3/16; G06F 3/0481

(52) U.S. Cl. CPC G06F 3/0482; G06F 3/04817; G06F 3/0488; G06F 3/167

(57) ABSTRACT

The current document is directed to flow-presentation methods, and systems that incorporate these methods that address needs of many elderly users for a simpler, more intuitive computer-system interface that continuously presents user-interface features to users that allow users to access and use programs, rather than waiting for a user to actively search for, and select, program entries. The currently described flow-presentation methods are incorporated into computer systems to create platforms that provide a continuous flow of news, entertainment, weather, scheduled events, and other information, referred to as “content,” to a user's computer, such as a mobile computing device, including cell phones, tablets, and laptops, a desktop computer, or an interactive television. The flow of content may, in certain implementations, continuously repeat as a sequence or presented information, like a carousel.

### CROSS-REFERENCE TO RELATED APPLICATION

This application claims the benefit of Provisional Application No. 61/992,182, filed May 12, 2014.

### TECHNICAL FIELD

The current document relates to automated information presentation and computer interaction and, more particularly, a method and system that presents information in a flow presentation mode.

### BACKGROUND

As we age, our ability to manage multiple simultaneous inputs diminishes. This loss of ability creates stress and resistance to technology usage, often resulting in older adults choosing to disengage from computer systems, rather than to suffer continued stress, and, as a result, to experience isolation from others as a result of a failure to interact with others through computer-enabled communications facilities.

Current computer interfaces offer a plethora of buttons, icons, directories, and options from which to choose. Current operating systems and presentation platforms provide complex, drill-down interfaces. To use these interfaces, a user needs to know and understand specialized verbal and icon/image vocabularies and needs a good short-term memory combined with a mental map of the program interface. To manage a computer, the user needs to have an ability to combine a graphical representation of the interfaces with a level of system knowledge. In order to utilize the functionality of the system, a user needs to know where and what to look for and to actively select program entries. The complex skills and abilities needed to operate computer systems often results in frustration and intimidation for unaccustomed and/or elderly users.

### SUMMARY

The current document is directed to flow-presentation methods, and systems that incorporate these methods that address needs of many elderly users for a simpler, more intuitive computer-system interface that continuously presents user-interface features to users that allow users to access and use programs, rather than waiting for a user to actively search for, and select, program entries. The currently described flow-presentation methods are incorporated into computer systems to create platforms that provide a continuous flow of news, entertainment, weather, scheduled events, and other information, referred to as “content,” to a user's computer, such as a mobile computing device, including cell phones, tablets, and laptops, a desktop computer, or an interactive television. The flow of content may, in certain implementations, continuously repeat as a sequence or presented information, like a carousel.

### BRIEF DESCRIPTION OF THE DRAWINGS

FIG. 1 shows a clock display.

FIG. 2 shows an application first page of a weather application.

FIG. 3 shows a further breakdown of the weather provided by the weather application.

FIG. 4 shows a community-event-calendar first page of a community-events application.

FIG. 5 shows user input to a button “Corner Store” of the community-event-calendar first page.

FIG. 6 shows a change in the appearance of the “Corner Store” button following user input.

FIG. 7 shows menus displayed to a user.

FIG. 8 shows display of a new application first page following a user prompt.

FIG. 9 shows intervention is automated information display, by a user, in order to post a reply, as shown below in Figure.

FIG. 10 shows that a user can also prompt the platform to initiate an outbound call.

FIGS. 11A-G show additional system features and implementation details.

### DETAILED DESCRIPTION

The currently described flow-presentation methods, and systems that incorporate these methods, that address needs of many elderly users for a simpler, more intuitive computer-system interface that continuously presents choices for facilities to access and use rather than waiting for a user to actively search for, and select, program entries. The currently described flow-presentation methods are incorporated into computer systems to create platforms that provide a continuous flow of news, entertainment, weather, scheduled events, and other information, referred to as “content,” to a user's computer, such as a mobile computing device, including cell phones, tablets, and laptops, a desktop computer, or an interactive television. The flow of content may, in certain implementations, continuously repeat as a sequence or presented information, like a carousel.

In certain implementations, each type of content may be the front page displayed by an application. The front page displayed by each application appears on the screen for a predetermined length of time before being replaced by the front pages displayed by a next application. When the carousel of application front pages reaches a last application front page of the sequence, the sequence again repeats, starting with a first front page of the sequence.

The interface presents these application front pages as choices for the user to drill down or focus on specific content, thus inviting the user to engage with the device according to his or her preferences. The user engages either through touch, on touch-enabled devices, through voice, on voice-enabled devices, or through other input methods, including a computer mouse. Engagement can mean gathering more information on a certain topic, signing up for an event, buying an item, or taking a related action, including initiating a video chat with a person who has sent an electronic greeting.

The flow and types of content to be delivered to a user can configured by the user or by a 3^{rd}-party content administrator, and can then be modified by the user in the course of use. At any time in the flow of content, a user can intervene and request a specific application without waiting for the carousel to run through the sequence of application first pages.

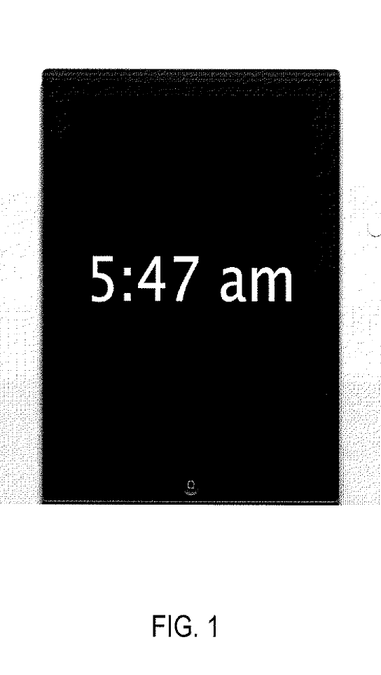

Next, what a user may see and how a user may interact with a flow-presentation platform is illustrated in an example. In this example, the carousel of displayed application first pages begins with a clock interface, as depicted below in FIG. 1. The associated application may be passive, only displaying a clock interface, or the application may allow the user to select the displayed screen or give a verbal prompt to set an alarm.

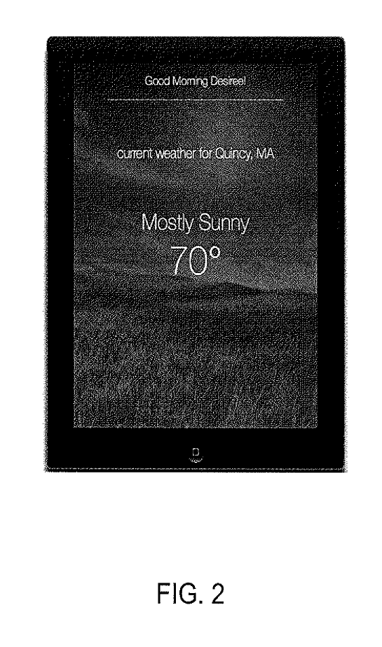

After a set period of time, for example 20 seconds, without interaction from the user, the carousel of application first pages advances and automatically displays a next application first page, such as a weather application as depicted below in FIG. 2:

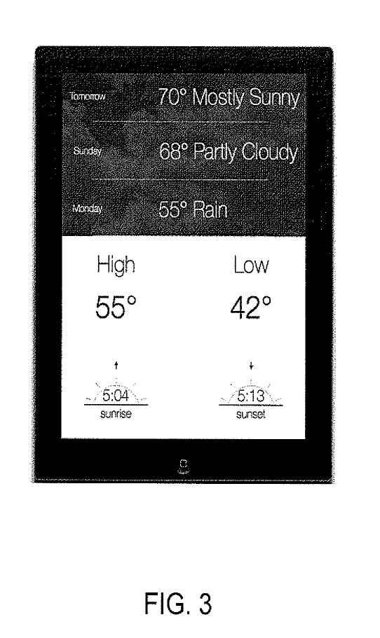

The user can let the carousel of application first pages proceed to the next application first page, or, at any time, the user can prompt the application, the front page of which is currently displayed, by touch, click or voice. For example, when the user prompts the weather application by touching the screen or saying “More information,” the weather application provides a further breakdown of the weather, as seen below in FIG. 3:

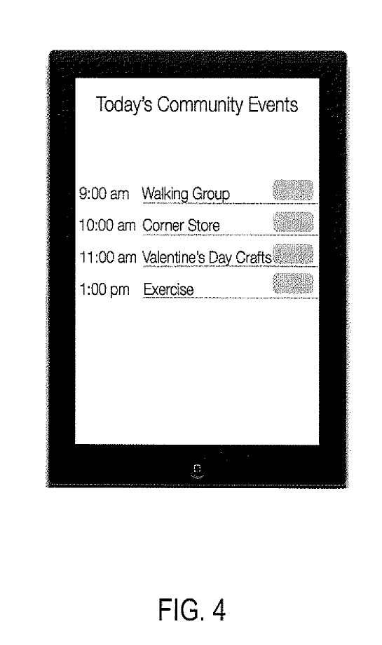

When no further prompt, after a set period of time, is input by the user, the presentation flow returns to displaying the next application first page in the carousel sequence, such as the community-event-calendar first page of a community-events application, shown in FIG. 4:

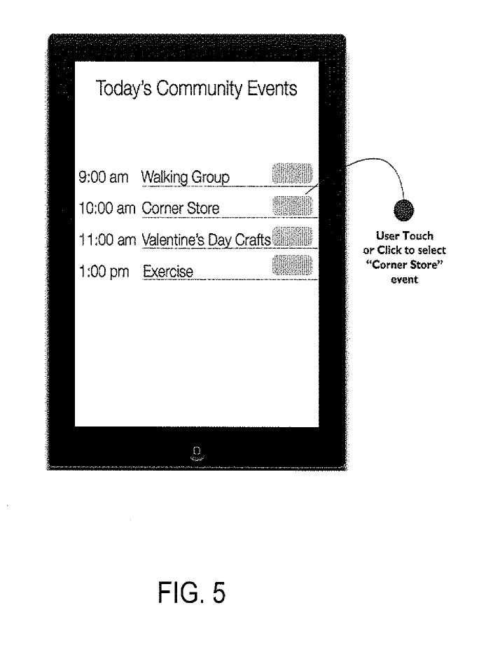

The community-event-calendar first page presents options from among which the user can select an option. For example, the user may want to sign up for the bus to the corner store. He or she touches or clicks the button “Corner Store,” as shown below in FIG. 5:

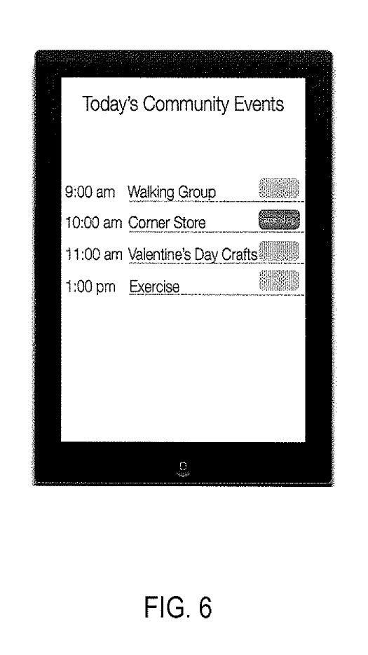

The community-events application then shows that the user is now planning to attend the event by changing the button to display the label “attending,” as shown in FIG. 6, below. The user's action may also result in the user's online calendar being populated with the event, notify the organizers of the event that the user wants to attend, forward the user to a payment screen, or perform some other function.

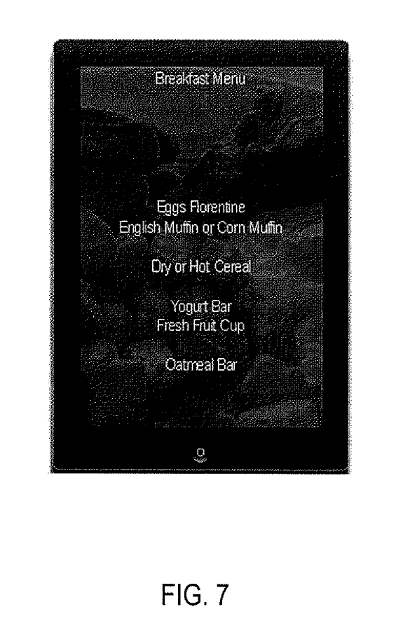

Other applications on the carousel could present other information specific to community events, such as the menus shown in FIG. 7:

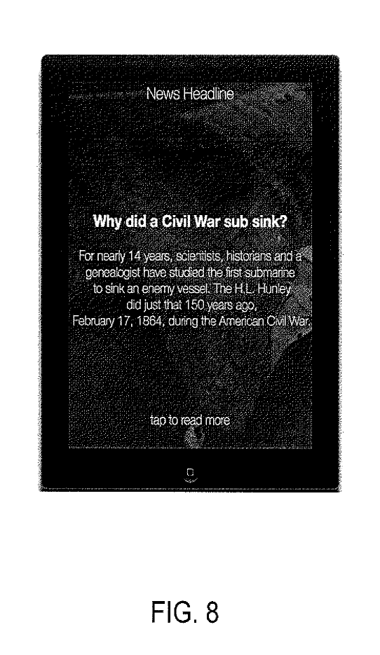

In addition, applications may provide news, sports, financial information, and other types of content to users. Although this content may be provided “passively” without a specific request from the user, a user can actively prompt the system to provide more information by using a click, touch or voice prompt to intervene temporarily in the flow of application first pages and displayed content. After such a prompt, a new application first page may be displayed, as shown in FIG. 8:

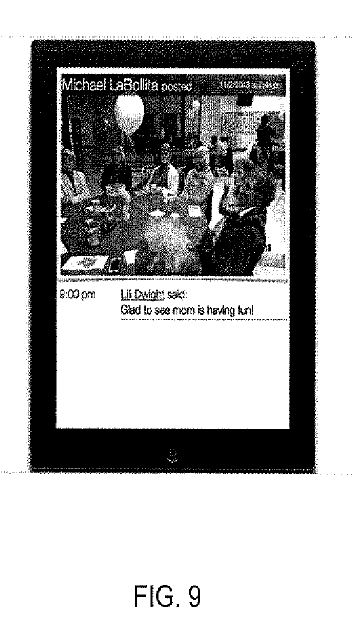

An application may also include inbound email or chat together with rich content, including pictures, audio messages, video, etc. A user can intervene by clicking or touching a message in order to post a reply, as shown below in FIG. 9.

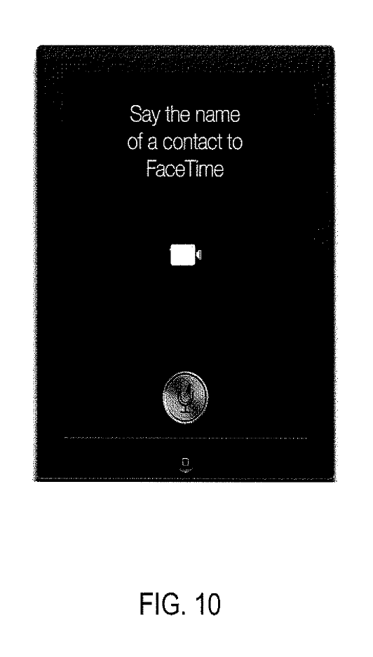

The user can also prompt the platform to initiate an outbound call by saying “Call” and then the name of the contact, as shown in FIG. 10:

The platform's presentation and application-access method is not only simple and engaging, but can be extended by adding additional applications in the future. The combination of the access method and a set of universal commands that interrupt, drill down, and then restart the flow of content provide a simple user interface that is accessible even to elderly users and to those unfamiliar with computer systems.

The platform is managed with a collection of specific voice commands and gestures for navigation. These voice commands and gestures are integrated into the platform. For example, the user can touch the screen or issue a voice command to further engage an application. When, for example, a daily newspaper is in the display foreground, the user may scroll down to read further or may touch links to follow an interest to a different article or page. A simple gesture or voice command returns the user interface to a continuous-information-flow mode.

When the flow is displaying one application first page or content and when the user desires display of other content, the user may issue a voice command or gesture to invoke a different application. In this way, the user is always being offered an opportunity to engage with the world through a wide variety of applications, such as calendars, photos, messaging, menus, topic of the day, news, reminders, volunteering opportunities, books, special multi-user games, and other content. The invitation to engage is an active process, rather than the current passive process provided by current computing devices.

As well as inviting the user to engage, the system provides a “low noise” interface that reduces stress. The meaning of “low noise,” in this context, is the elimination of non-pertinent information from the display. The user sees only the current application-displayed first page or other application-provided content in the flow. By contrast, FaceBook, for example, displays ads, chats, games, pokes, friends, groups, and other such content, which may distract, disorient, and frustrate the user. FaceBook is thus a “high noise” platform.

The currently described information-flow-based system and platform is initially implemented as an iOS application and is therefore written and compiled specifically for iOS and the 64-bit ARM architecture. Utilizing Cocoa Touch as the user-interface (“UI”) framework, the application is written in the Objective-C language according to the Xcode development environment of Apple's iOS SDK. From a hierarchical viewpoint, the application layers, from highest to lowest, consist of Cocoa Touch, Media and Application Services, Core Services and the Core OS/iOS kernel.

At the Media/Application Services layer, the flow-based application draws from other content providers via APIs. Streams of content are updated continuously or on-demand according to the capabilities of content providers. The functionality of enabling users to interrupt and then resume the flow of application content is written into the Core Services level. Flow application may also be written in Java programming language using the Android Software Development Kit or in other languages and formats.

In the setup phase, a user or administrator arranges a set of applications into a chain carousel, a repeating sequence of applications that restarts at the beginning of the chain once it reaches the end, via a set-up function. In this set-up function, the icons of all application are displayed on the screen as menu choices together with a graphic interface, permitting editing of the icon carousel. A user/administrator drags the application icons with a mouse or using touch to form a specific sequence with appropriate application icons displayed each time when the user uses the system in a presentation phase. The user/administrator can further interactively add, delete, move, or duplicate items in the carousel using graphical-interface features, and additionally adds identification information, such as screen names, IDs, and passwords. For each item in the carousel, a duration of display is set up/programmed using the same screen. At the end of the set-up phase, the chain carousel is saved.

In the presentation phase, first pages of the applications that have been programmed into the carousel during the set-up phase are presented on the screen one-at-a-time in the order and for a time duration specified during the set-up phase. At any time during the presentation of a particular application, the user can activate the displayed application using click, touch or voice. At every moment during the presentation phase, the user can give a predetermined voice command to display names and application icons for all applications that have been programmed into the carousel during the set-up phase, accompanied with preset voice commands intended to call each particular application. After this, the user can issue a voice command from the displayed set to call a desired application. In this manner, the user can call any application at any time and interrupt the sequence of the carousel display in order to immediately call a desired application.

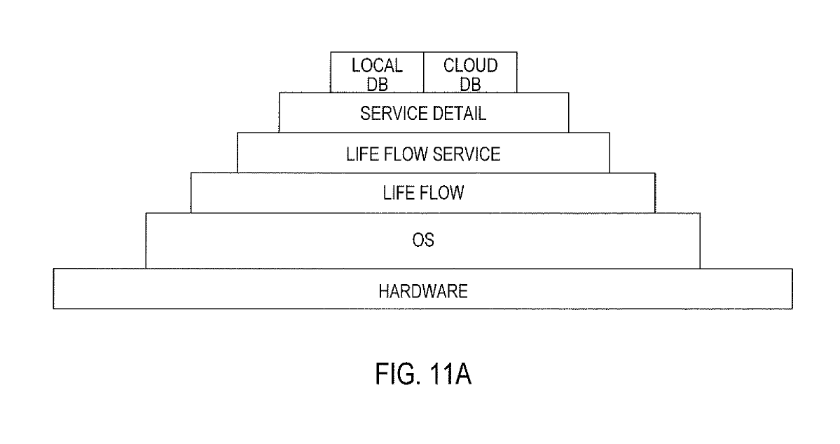

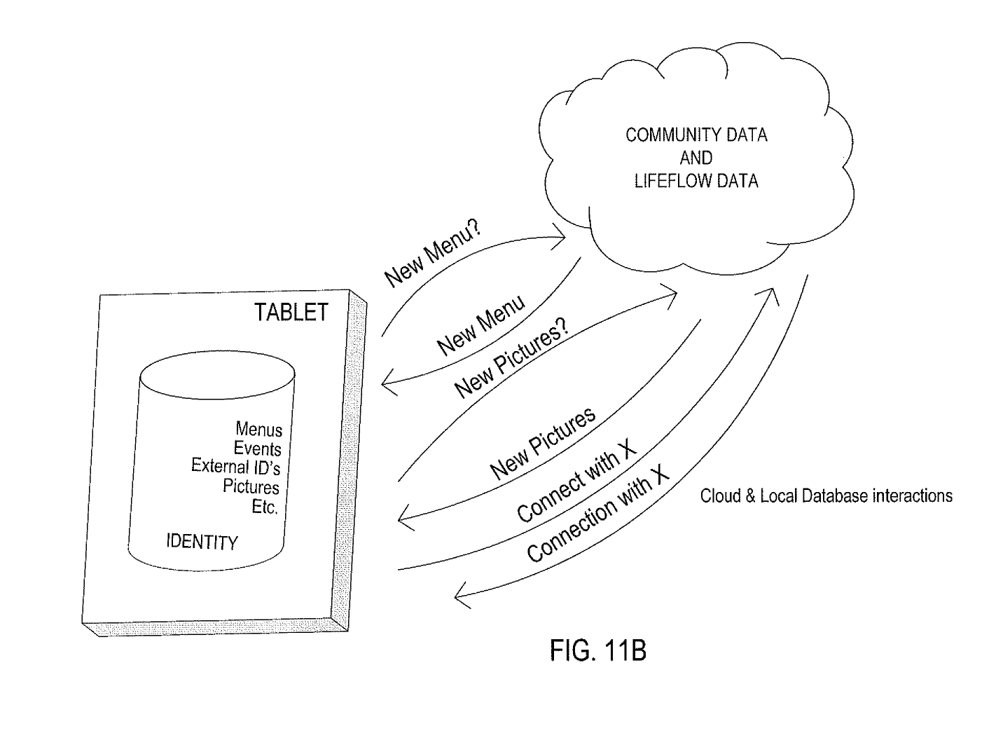

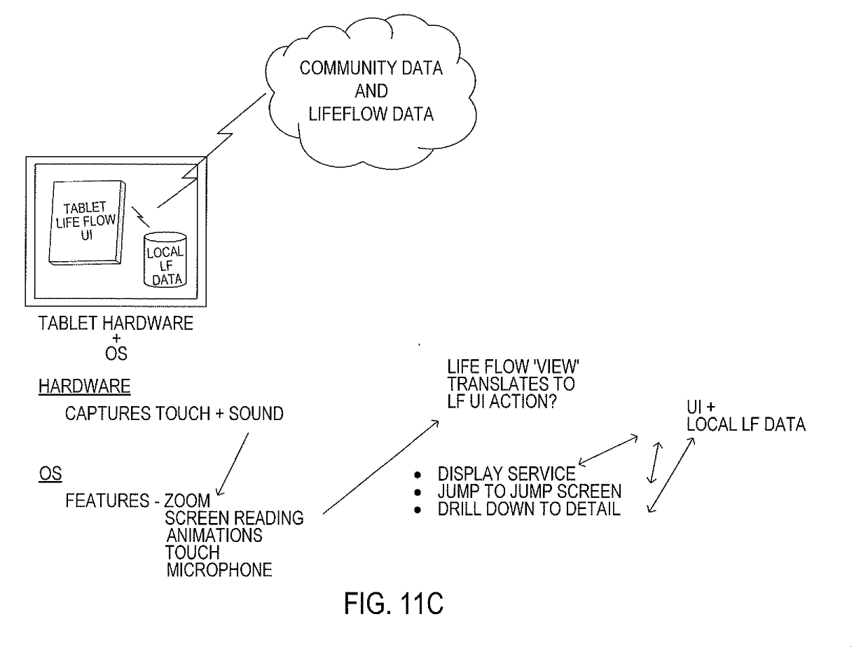

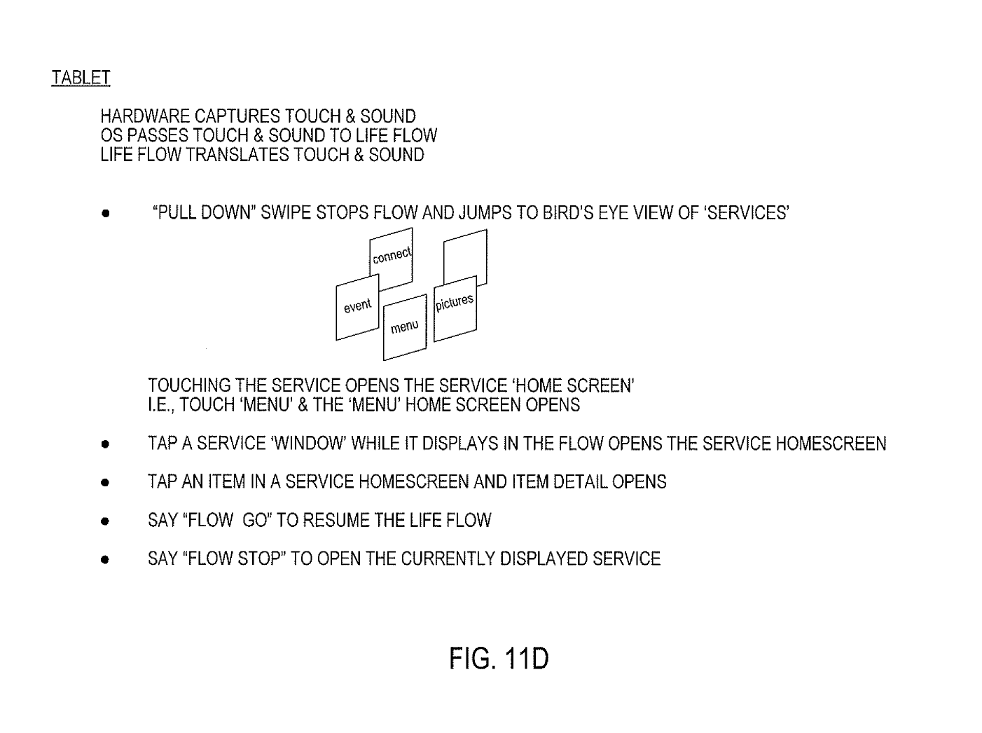

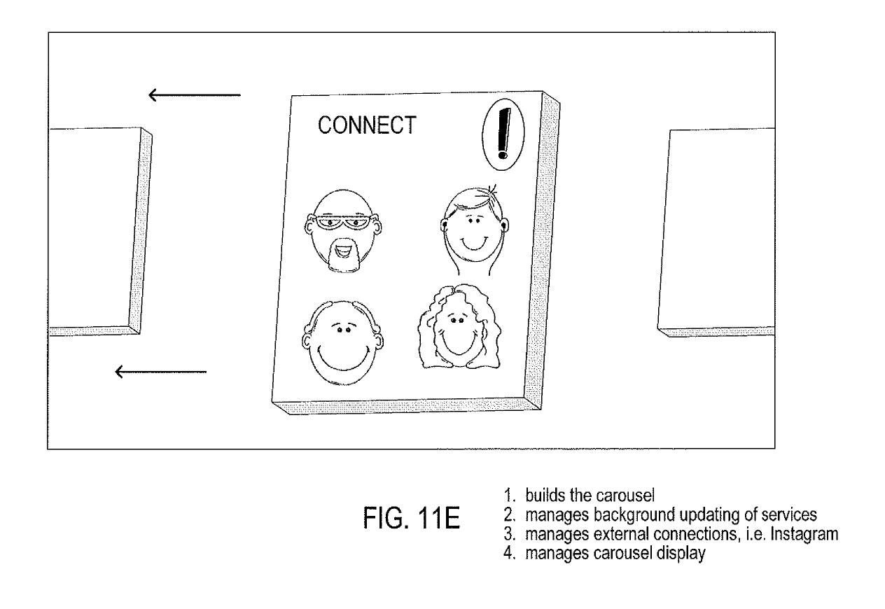

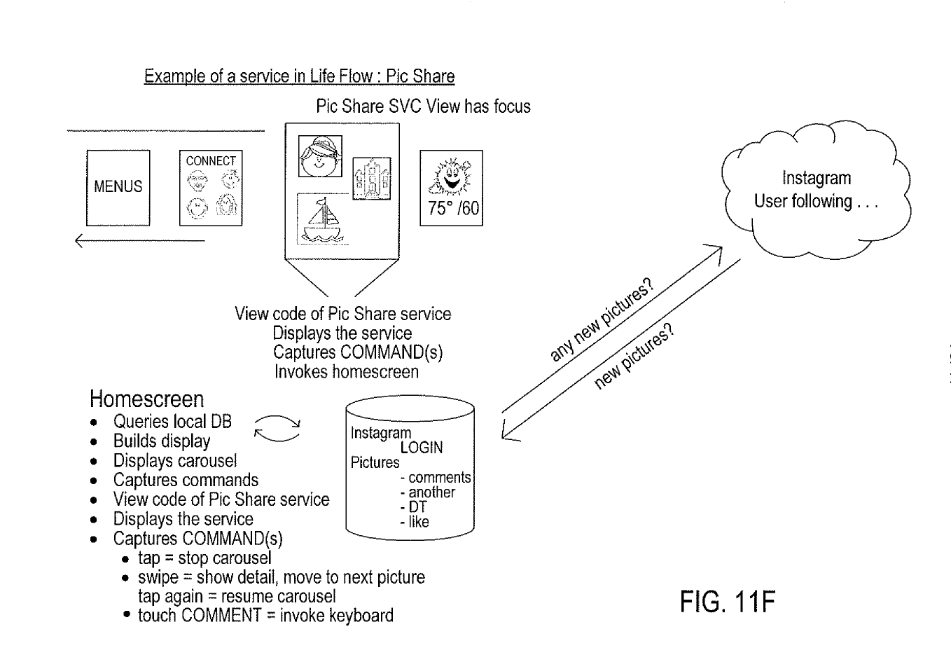

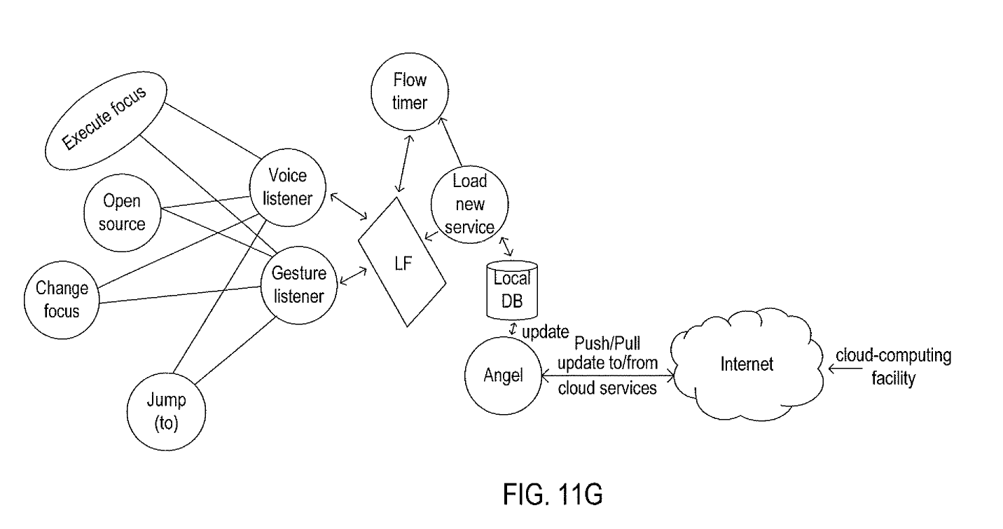

The system additionally includes a repository for applications, a supporting framework for presenting content and interacting with the platform, and a gateway to allow users and developers to access the applications. Additional system features and implementation details are shown in FIGS. 11A-G.

1. A flow-presentation system comprising:
a computer and computer operating system; and
a flow-presentation application executing on the computer within an execution environment provided by the computer operating system that organizes a set of applications into a carousel, first pages or other content associated with which are continuously displayed to a display device, with user input controlling the display sequence and display of additional information by applications in the carousel.
